(19) United States
(12) Patent Application Publication
(10) Pub. No.: US 2025/0102094 A1
(43) Pub. Date: Mar. 27, 2025

(54) TRANSITION COUPLING AND CONDUIT ASSEMBLY

(71) Applicant: S-P Products, Inc., Elk Grove Village, IL (US)

(72) Inventor: Mikel Bishka, Wheaton, IL (US)

(21) Appl. No.: 18/898,156

(22) Filed: Sep. 26, 2024

Related U.S. Application Data
(60) Provisional application No. 63/540,748, filed on Sep. 27, 2023.

(51) Int. Cl. F16L 43/02; F16L 43/00

(52) U.S. Cl. CPC F16L 43/02; F16L 43/001

(57) ABSTRACT

A transition coupling, and conduit assembly, are configured to promote efficient and cost-effective assembly of conduit components for housing electrical wiring and the like in buildings and other structures. The transition coupling comprise metallic and non-metallic elements joined to each other, which elements, in turn, can be joined to associated metallic and non-metallic conduit sections. A pair of the transition coupling elements can be used at opposite ends of a rigid metallic elbow or the like to facilitate assembly with non-metallic conduit sections.

### CROSS-REFERENCE TO RELATED APPLICATIONS

This application is a Non-Provisional which claims priority of Provisional Application No. 63/540,748, filed Sep. 27, 2023, the disclosure of which is hereby incorporated by reference in its entirety.

### FIELD OF THE INVENTION

The present invention relates generally to conduit components typically employed in buildings and other structures for housing electrical wiring and related components, and more particularly to a transition coupling and conduit assembly which promote efficient and cost-effective installation.

### BACKGROUND OF THE INVENTION

The use of conduit components and assemblies is widespread in the construction industry for housing electrical wiring and related components. Such conduit sections can comprise rigid metallic materials, or polymeric materials, typically polyvinyl chloride (PVC).

Ordinarily the conduit components are assembled and installed as required, with the associated electrical wiring threaded or otherwise placed in position within the conduit. Because a structure or other project may comprise a large number of electrical components, an arrangement which promotes fitment and assembly of the conduit sections can provide desired cost-savings and efficiency for the project.

The present invention is directed to a transition coupling, and conduit assembly, and method of formation which promote efficient and cost-effective assembly of conduit components for subsequently housing electrical wiring and components.

### SUMMARY OF THE INVENTION

In accordance with the present invention, a transition coupling and associated conduit assembly are disclosed which promote efficient and cost-effective installation.

In accordance with one aspect of the invention, the present conduit assembly comprises first and second transition couplings. Each of the transition couplings comprises: (1) a metallic rigid coupling having a generally tubular configuration and defining an internal thread formation, and (2) a rigid connector element having a generally tubular configuration having a first end having an outside diameter, and an opposite second end having an external thread formation threaded, and adhered, to the internal thread formation of said metallic rigid coupling.

The present conduit assembly further comprises a rigid conduit element having a tubular configuration. This component may be configured as a so-called rigid elbow, having a 90 degree or right-angle configuration. The rigid conduit element, typically metallic, defines external thread formations at opposite ends thereof. Notably, the metallic rigid coupling of each of the first and second transition couplings are respectively threaded to the opposite ends of the rigid conduit element.

The present assembly further includes first and second bell end adapters each having a tubular configuration. Each bell end adapter includes a first end having a first outside diameter, and a second opposite end having an outside diameter greater than the outside diameter of said first end.

The completed assembly includes the rigid connector element of each of the first and second transition couplings being respectively adhered to the inside of each of the first and second bell end adapters at the second ends thereof.

In accordance with the present invention, a method of forming a conduit assembly comprises the steps of providing first and second transition couplings. Each transition coupling comprises: (1) a metallic rigid coupling having a generally tubular configuration, and defining an internal thread formation, and (2) a rigid connector element having a generally tubular configuration, and having a first end having an outside diameter, and an opposite second end having an external thread formation threaded into the internal thread formation of the metallic rigid coupling.

The present method next includes providing a rigid conduit element having a tubular configuration, wherein the conduit element defines external thread formations at opposite ends thereof. The metallic rigid coupling of each of the first and second transition couplings is threaded to a respective external thread formations at opposite ends of the rigid conduit element.

First and second bell end adapters are provided, each a having a tubular configuration. Each bell end adapter includes a first end having a first outside diameter, and a second opposite end having an outside diameter greater than the outside diameter of said first end.

Finally, assembly is completed by adhering the first and second bell end adapters to the respective ones of the rigid connectors of said first and second transition couplings. Associated PVC conduits can now be efficiently joined to the first and second bell end adapters.

Other features and advantages of the present invention will be readily apparent from the following detailed description, the accompanying drawings, and the appended claims.

### BRIEF DESCRIPTION OF THE DRAWINGS

FIG. 1 is a diagrammatic view of a conduit assembly embodying the principles of the present invention;

FIG. 2 is an exploded diagrammatic view further illustrating the conduit assembly embodying the principles of the present invention; and

FIG. 3 is a diagrammatic view of a transition coupling that can be used from practicing the present invention.

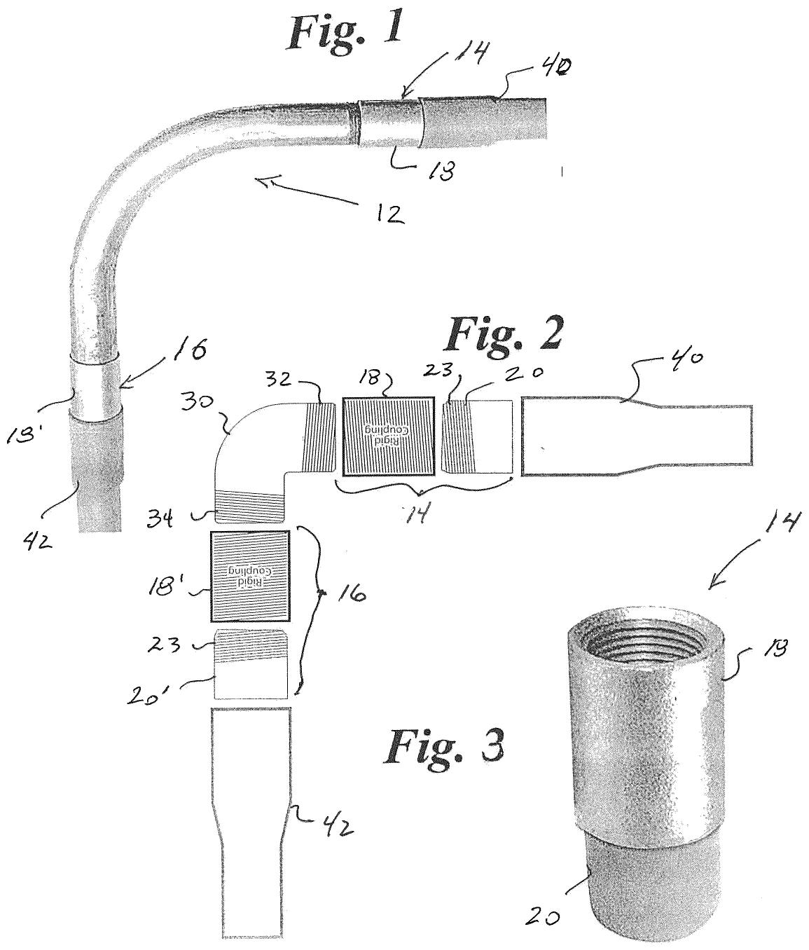

### DETAILED DESCRIPTION OF THE INVENTION

While the present invention is susceptible to embodiment in various forms, there is shown in the drawings and will hereinafter be described a presently preferred embodiment, with the understanding that the present disclosure is intended as an exemplification of the invention, and is not intended to limit the invention to the specific embodiment that is illustrated.

In accordance with the present invention, a conduit assembly, designated 12, including first and second transition couplings 14, 16, promotes efficient and cost-effective installation.

Notably, the present invention facilitates joining conduit sections formed from polyvinyl chloride (PVC) with other rigid, metallic conduit sections, as is frequently required in a typical construction. The arrangement meets NEC Article 500.8 Requirements, while positioning PVC couplings below concrete screed level.

Practice of the invention desirably provides transitions without reaming of PVC conduit, and eliminates damage and rework, with savings of materials and labor. The arrangement also meets the 2-hours building code, and is Underwriters Laboratory listed.

In accordance with one aspect of the invention, the present conduit assembly 12 comprises the first and second transition couplings 14 and 16. Each of the transition couplings 14, 16 comprises: (1) a metallic rigid coupling, 18, 18′, having a generally tubular configuration and defining an internal thread formation, and (2) a rigid connector element, 20, 20′, having a generally tubular configuration having a first end having an outside diameter, and an opposite second end having an external thread formation, at 23, threaded and adhered to the internal thread formation of the metallic rigid coupling 18, 18′.

The present conduit assembly further comprises a rigid conduit element 30 having a tubular configuration. This component may be configured as a so-called rigid elbow, having a 90 degree or right-angle configuration. The rigid conduit element, typically metallic, defines external thread formations 32, 34, at opposite ends thereof. Notably, the metallic rigid coupling 18, 18′ of each of the first and second transition couplings 14 and 16 are respectively threaded to the opposite ends of the rigid conduit element 30.

The present assembly further includes first and second bell end adapters 40. 42, each having a tubular configuration. Each bell end adapter 40, 42 includes a first end having a first outside diameter, and a second opposite end having an outside diameter greater than the outside diameter of said first end.

The completed assembly 12 includes the rigid connector element 20, 20′ of each of the first and second transition couplings being respectively adhered to the inside of each of the first and second bell end adapters 40, 42 at the second ends thereof.

In accordance with the present invention, a method of forming the conduit assembly 12 comprises the steps of providing first and second transition couplings 14, 16. Each transition coupling comprises: (1) a metallic rigid coupling 18, 18′ having a generally tubular configuration, and defining an internal thread formation, and (2) a rigid connector element 20, 20′ having a generally tubular configuration. Each rigid connector element 20, 20′ has a first end having an outside diameter, and an opposite second end having an external thread formation at 23 threaded into the internal thread formation of the metallic rigid coupling 18, 18′.

The present method next includes providing a rigid conduit element having a tubular configuration, wherein the conduit element defines external thread formations at opposite ends thereof. The metallic rigid coupling of each of said first and second transition couplings is threaded to a respective external thread formations at the opposite ends of the rigid conduit element.

First and second bell end adapters, typically PVC, are provided each having a tubular configuration. Each bell end adapter includes a first end having a first outside diameter, and a second opposite end having an outside diameter greater than the outside diameter of said first end.

Finally, assembly is completer by adhering the first and second bell end adapters to the respective ones of the rigid connectors 20, 20′ of said first and second transition couplings 14,16.

Thus, the present invention contemplates that the galvanized rigid elbow 30 can be installed below grade using the transition couplings 14, 16 to transition from galvanized rigid conduit to Schedule 40 and 80 PVC conduit. This transition meets NES Article 500.8 requirements.

The bell end adapters 40, 42 of PVC conduit are adhered to the rigid connectors 20, 20′ of the transition couplings, and the PVC raceway continued. The construction can be configured to meet UL651, CSA CSS.L Ng83, and US Army Corps or Engineers Specs.

From the foregoing, it will be observed that numerous modifications and revisions can be effected without departing from the true spirit and scope of the present invention. The disclosed is intended to cover, by the appended claims, all such modifications that fall within the scope of the claims.

1. A conduit assembly, comprising:
first and second transition couplings, each of said transition couplings comprising: (1) a metallic rigid coupling having a generally tubular configuration, and defining an internal thread formation, and (2) a rigid connector element having a generally tubular configuration having a first end having an outside diameter, and an opposite second end having an external thread formation threaded to the internal thread formation of said metallic rigid coupling;
a rigid conduit element having a tubular configuration, said conduit element defining external thread formations at opposite ends thereof, said metallic rigid coupling of said first and second transition couplings being respectively threaded to the opposite ends of said rigid conduit element, and
first and second bell end adapters each having a tubular configuration, and each including a first end having a first outside diameter, and a second opposite end having an outside diameter greater than the outside diameter of said first end,
said rigid connector elements of each of said first and second transition couplings being respectively adhered to the inside of each of said first and second bell end adapters at the second ends thereof.

2. A conduit assembly in accordance with claim 1, wherein
said rigid conduit element comprises a 90-degree rigid elbow defining a right-angle.

3. A method of forming a conduit assembly, comprising the steps of:
providing first and second transition couplings each comprising: (1) a first metallic rigid coupling having a generally tubular configuration, and defining an internal thread formation, and (2) a first rigid connector element having a generally tubular configuration, and having a first end having an outside diameter, and an opposite second end having an external thread formation threaded into the internal thread formation of said metallic rigid coupling; and (2), one end of said internal thread formation being threaded to said external thread formation of said rigid coupling;
providing a rigid conduit element having a tubular configuration, said conduit element defining external thread formations at opposite ends thereof,
threading said metallic rigid coupling of each of said first and second transition couplings respective external thread formations at opposite ends of said rigid conduit element;
providing first and second bell end adapters each a having a tubular configuration, each including a first end having a first outside diameter, and a second opposite end having an outside diameter greater than the outside diameter of said first end; and
adhering said first and second bell end adapters to the respective ones of said rigid connectors of said first and second transition couplings.
